(19) United States
(12) Patent Application Publication
(10) Pub. No.: US 2014/0252187 A1
(43) Pub. Date: Sep. 11, 2014

(54) MODULAR MOUNTING SYSTEM USING PICATINNY-TYPE RAIL

(71) Applicant: Cody Petrovic, Weyers Cave, VA (US)

(72) Inventor: Cody Petrovic, Weyers Cave, VA (US)

(21) Appl. No.: 14/173,354

(22) Filed: Feb. 5, 2014

Related U.S. Application Data
(60) Provisional application No. 61/760,980, filed on Feb. 5, 2013.

(51) Int. Cl. F16M 13/02; F16B 2/18

(52) U.S. Cl. CPC F16M 13/02; F16B 2/185
USPC 248/229.16

(57) ABSTRACT

A system for mounting one article to another article incorporates a clamp having a base configured to interlock with a Picatinny-type rail. In one form, the clamp has a quick-connect device serving as a platform for quickly attaching different articles to the clamp, and in another form a coupler joins two clamps that are attachable to respective different rails. The clamp preferably is spring biased to one position and manually operated to a second position to facilitate application to and removal from the rail. The invention thus provides an easily customizable equipment rack that can be mounted to almost any surface, allowing it to be extremely versatile. For example, it could be used to mount a shelf to a wall surface, or for supporting tools, weapons, and other articles on various structures, or for mounting accessories to a weapon or to other objects.

### TECHNICAL FIELD

This invention relates to devices and systems for mounting one article to another article. More particularly, the invention relates to a modular system including at least one Picatinny-type rail attachable to a surface, and a clamp attachable to the rail at desired adjusted positions along the length of the rail. According to one aspect of the invention, the clamp has a base that interlocks with the rail and a quick-connect device for mounting an article to the clamp. According to another aspect, a coupler interconnects two clamps that are attachable to separate rails.

### BACKGROUND ART

There are myriad devices and systems for mounting a first article to a second article, including vertically oriented rails mounted to a wall in horizontally spaced relationship to one another and to which shelf brackets can be attached for supporting a shelf on a wall. U.S. Pat. Nos. 3,631,821, 6,179,136, and 6,220,463, and published US patent application 2010/0213334 are exemplary of such systems, wherein shelf support brackets have projections engaged in apertures in rails attached to a wall.

Picatinny-type rails and Weaver rails are used for mounting various accessories to weapons. One or more rails are attached to the weapon and an accessory is mounted on the rail. U.S. Pat. Nos. 3,877,166, 4,845,871 and 8,127,484 are exemplary of such systems. The devices disclosed in these patents utilize a cam lock structure to mount the accessory to the rail.

None of the prior art devices utilize a Picatinny-type rail for mounting accessories to surfaces other than a weapon, and particularly for mounting shelves to a wall. The prior art devices especially do not disclose a system utilizing a clamp having a base configured to interlock with the rail, and a quick-correct device for quickly and easily attaching different articles to the clamp and thus to the rails. Moreover, applicant is not aware of any prior devices that incorporate a coupler joining two clamps attachable to different rails.

It would be desirable to have a modular system for mounting one article to another article, wherein the system incorporates a Picatinny-type rail to which is mounted a clamp having a base configured to interlock with the rail, and particularly to such a system incorporating a quick-connect device serving as a platform for quickly and easily attaching different articles to the clamp and thus to the rail, and/or to such a system that incorporates a coupler joining two clamps attachable to different rails. The invention could be used for many purposes, including mounting a shelf to a wall surface, or for supporting tools, weapons, and other articles on various structures.

### SUMMARY OF THE INVENTION

The invention comprises a modular system for mounting one article to another article, wherein the system incorporates a Picatinny-type rail to which is mounted a clamp having a base configured to interlock with the rail. According to one aspect of the invention, a quick-connect device is attached to the clamp and serves as a platform for quickly and easily attaching different articles to the clamp and thus to the rail. The clamp preferably is spring biased to one position and manually operated to a second position to facilitate application to and removal from the rail. According to another aspect, a coupler joins two clamps that are attachable to different rails. The invention thus provides an easily customizable equipment rack that can be mounted to almost any surface, allowing it to be extremely versatile. For example, it could be used to mount a shelf to a wall surface, or for supporting tools, weapons, and other articles on various structures, or for mounting accessories to a weapon or to other objects.

In one embodiment the clamp functions much like a bag clip, with pivoted clips on opposite sides of the clamp that have inturned clamping jaws spring biased into closed position against opposite sides of the rail and opened by squeezing clip arms toward one another to spread the jaws apart and release the clamp from the rail.

In another embodiment the clamp comprises opposed halves or jaws that are spring biased away from one another to an open position, and a cam lock is used to move the halves toward one another to secure the clamp in closed position against opposite sides of the rail. Cross pieces are fixed to the two halves of the clamp, with the cross pieces fixed to each half extending toward but free of attachment to the opposite half. The cross pieces attached to one half are slidably engaged with the cross pieces attached to the opposite half, and detents on the inner ends of the cross pieces prevent the clamp halves from spreading too far apart. The cam lock includes a rod fixed at one end to one half of the clamp and slidably extending at its other end through the opposite clamp half. A cam member is attached to said other end of the rod on the outside of the adjacent clamp half and is manipulated to press the two halves toward one another into engagement with opposite sides of the rail. A spring urges the halves apart. In addition to preventing the clamp from opening too far, the cross pieces also prevent the clamp halves from twisting and becoming misaligned when unlocked, which would cause problems while trying to install the clamp. Both halves of the clamp are identically shaped to make manufacturing easier.

In a further embodiment the clamp has one fixed jaw that engages one side of the rail and a movable jaw that engages the opposite side of the rail. Thumb screws are connected with the movable jaw to move it to an open position spaced from the rail or to a closed position against the rail. Springs may be provided to urge the jaws apart when the thumb screws are loosened.

In a still further embodiment the clamp has one fixed jaw that engages one side of the rail and a movable jaw that engages the opposite side of the rail. The movable jaw is spring biased into engagement with the rail, and one or more actuating bars are connected with the movable jaw to move it to open position away from the rail.

The quick connect makes the clamp a more user friendly platform for a variety of accessories that could attach to it, instead of using threaded connections. The quick connect makes the entire system more modular than using fixed accessories. The base is machined to interlock with the Picatinny-type rail to provide a positive mechanical lock against sliding of the clamp on the rail.

Since the clamp/platform uses the same rail found on weapons, it could also be mounted to the weapon itself to further increase the functionality of the modular system. For example, attaching the clamp/hook combination to a weapon allows the weapon to be hung on a railing or pipe. The coupler is particularly suited to this task.

Since the platform is a quick connect, there could be many accessories that could quickly and easily be attached to it, such as, for example, a triangle shelf bracket, a pistol holster, a Picatinny rail to Picatinny rail coupler, and others.

U-shaped hooks can be attached to the clamp of the invention to form a gun rack or to form a support or hanger for a variety of objects. A Velcro strap can be wrapped around the hook to hold objects in place. The hook preferably is made of aluminum and is easily deformed to grip the item supported in the hook.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is an isometric view of an assembly showing one use of the clamp of the invention, wherein some clamps are used to attach shelf brackets to spaced rails mounted on a wall for supporting a shelf, and other clamps are used to support hooks on the rails.

FIG. 2 is an enlarged fragmentary bottom isometric view of part of the assembly of FIG. 1, showing details of the shelf bracket attachment.

FIG. 3 is a top isometric view of a first embodiment of clamp according to the invention, shown in closed position.

FIG. 4 is a bottom isometric view of the clamp of FIG. 3.

FIG. 5 is a top isometric view of the clamp of FIGS. 2 and 4, shown in open position.

FIG. 6 is a top isometric view of a second embodiment of clamp according to the invention shown mounted to a Picatinny-type rail, with the clamp in the foreground shown in closed locked position and the clamp in the background shown in open unlocked position.

FIG. 7 is an exploded top isometric view of the clamp assembly of FIG. 6.

FIG. 8 is an exploded bottom isometric view of the clamp assembly of FIG. 6.

FIG. 9 is a top isometric view of the clamp used in the assembly of FIGS. 6-8.

FIG. 10 is a plan view of the clamp of FIG. 9.

FIG. 11 is a greatly enlarged exploded isometric view of the cam lock rod used in the clamp of FIG. 10.

FIG. 12 is a plan view of the quick connect used in the clamp of FIG. 6, shown in unlocked position.

FIG. 13 is a plan view of the quick connect used in the clamp of FIG. 6, shown in locked position.

FIG. 14 is a left side isometric view of a third embodiment of clamp according to the invention, shown in open unlocked position, wherein a movable jaw is spring biased to an open position moved away from an opposed fixed jaw, and thumb screws are connected with the movable jaw to draw it toward the fixed jaw.

FIG. 15 is a right side isometric view of the clamp of FIG. 14, shown in closed locked position.

FIG. 16 is a left side isometric view of a fourth embodiment of clamp according to the invention, shown in closed locked position, wherein a movable jaw is spring biased to an open position moved away from an opposed fixed jaw, and one or more actuating bars are connected with the movable jaw to move it to open position away from the fixed jaw.

FIG. 17 is a right side isometric view of the clamp of FIG. 16, shown in open unlocked position.

FIG. 18 is an exploded isometric view of a Picatinny-type rail and two different versions of clamps according to the invention.

FIG. 19 is a top isometric view of a hook that may be attached to the clamp of the invention, with a Velcro strip shown in broken lines.

FIG. 20 is an exploded isometric view showing two different types of clamp according to the invention positioned for attachment to a Picatinny-type rail.

FIG. 21 is an isometric view of a conventional utility hook for supporting an object, with a Velcro strap shown in broken lines.

FIG. 22 is an isometric view of a hook shown in inverted position and having slotted openings for securing the hook in different angularly adjusted positions.

FIG. 23 is an isometric view of a modification of the invention wherein a coupler joins two clamps to form a clamp assembly that can be used to attach one rail to another rail.

FIG. 24 is an exploded top isometric view of the clamp assembly of FIG. 23.

FIG. 25 is an exploded bottom isometric view of the clamp assembly of FIG. 23.

FIG. 26 is a top isometric view of the modified base used in the clamping member of FIGS. 23-25, wherein a locking tab is formed on one end of the base.

FIG. 27 is a top isometric view of the modified base of FIG. 27 assembled to the clamping member, with the cam lock in closed position and a padlock attached to it to secure it closed.

FIG. 28 is a top isometric view of a second form of coupler used to join two clamping members rotationally oriented 90° with respect to one another in a clamping assembly.

FIG. 29 is a fragmentary isometric view depicting the clamp assembly of FIG. 28 used to mount the vertically oriented rail on a firearm to a horizontal rail on a wall.

FIG. 30 is a top isometric view of a third form of coupler used to join two clamping members in a clamping assembly.

### DETAILED DESCRIPTION OF THE PREFERRED EMBODIMENTS

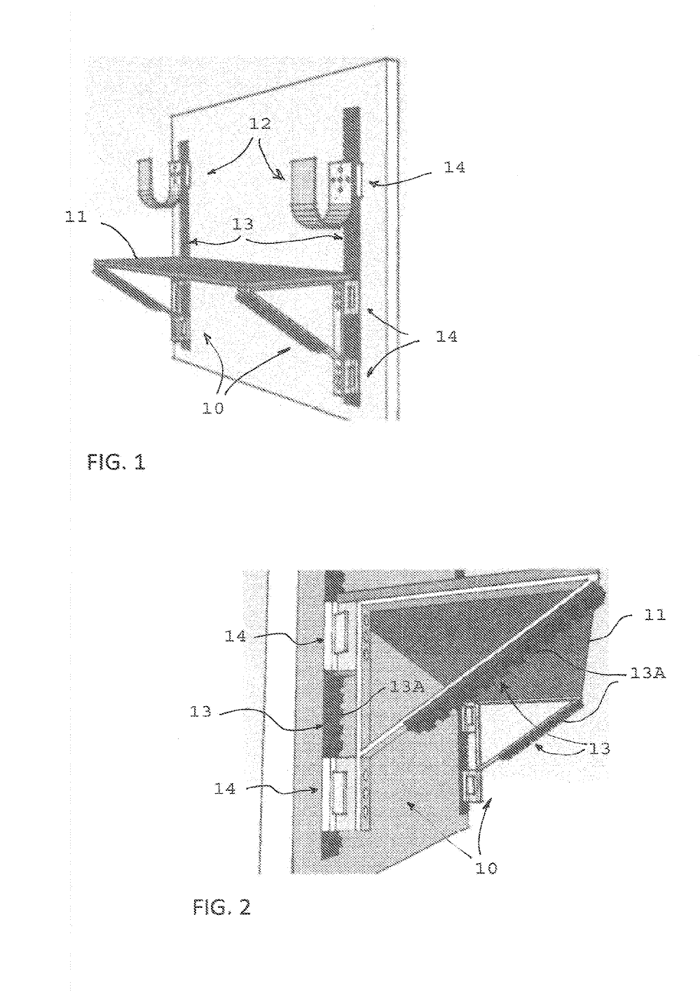

One potential application of the invention is shown in FIGS. 1 and 2, wherein two generally triangular shelf brackets 10 supporting a shelf 11, and two U-shaped hooks 12, are mounted on two horizontally spaced vertically oriented Picatinny-style rails 13 by a first embodiment of clamp 14 according to the invention.

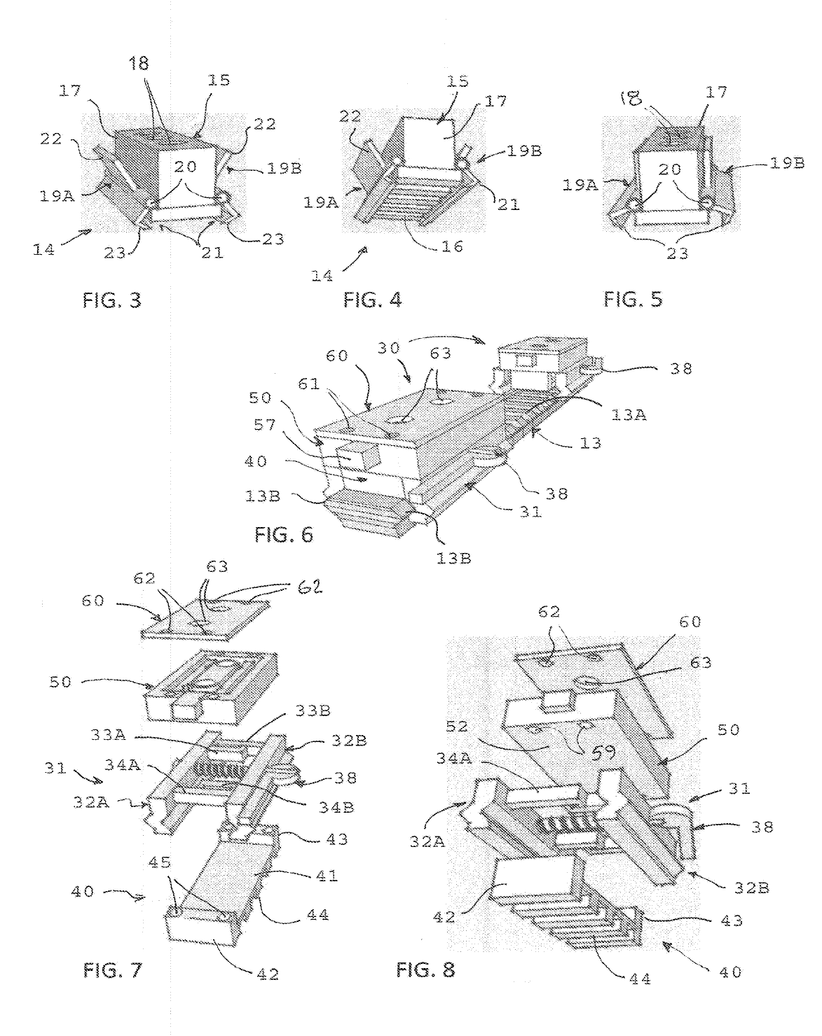

As seen best in FIGS. 3-5, the clamp 14 is operated similarly to a hair clip or bag clip and comprises a main body 15 having a grooved bottom surface 16 adapted to mesh with the grooved upper surface 13A on the rail 13, and an upper portion 17 with receptacles 18 in its upper surface adapted to receive threaded fasteners or quick-connect couplings (not shown) depending upon which type of connection is used. Clip elements 19A and 19B are pivotally mounted to opposite sides of the body 15 by hinge pins 20 and have depending legs or jaws 21 and arms or tabs 22 extending angularly upwardly from the jaws. Inturned flanges 23 on the bottom edges of the jaws are adapted to extend beneath shoulders 13B (seen best in FIG. 6) on the rails to hold the clamp 14 to the rail when the clip elements are in their closed position as shown in FIGS. 3 and 4. Movement of the clamp longitudinally of the rail is prevented by meshing of the grooved surfaces 13A and 16. The clip elements are biased to their closed position by a torsion spring (not shown) mounted on the hinge pins in a conventional manner, or by any other suitable biasing means, and are moved to an open position as shown in FIG. 5 by squeezing the arms 22 inwardly toward one another to disengage the flanges 23 from beneath the shoulders 13B.

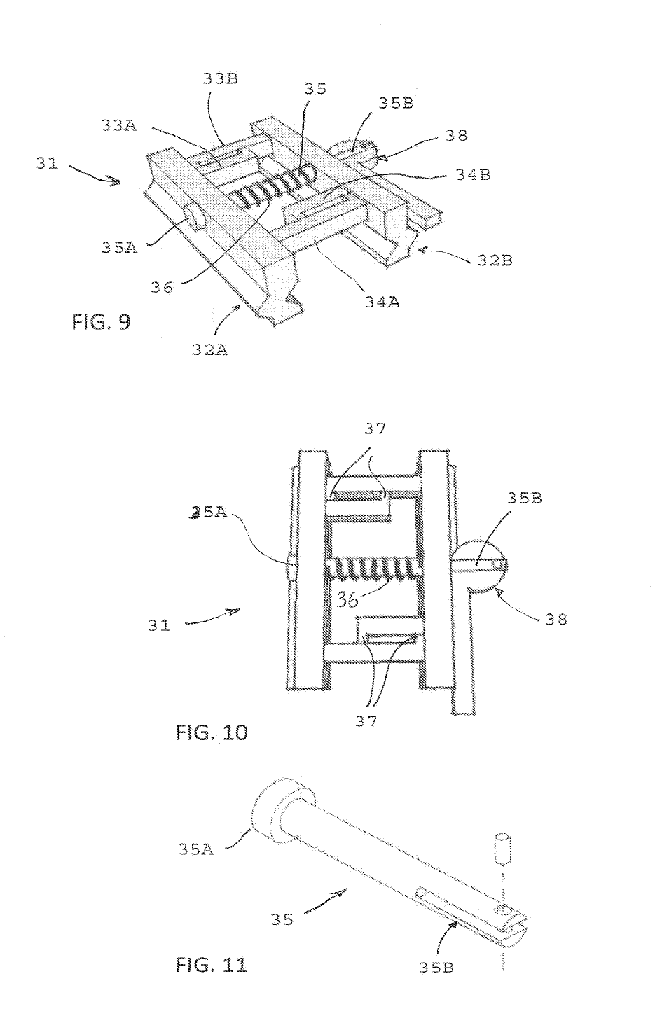

A second, preferred form of clamp according to the invention is shown at 30 in FIGS. 6-13. In FIG. 6 the clamp 30 is shown in the foreground in its locked condition and in the background in its unlocked condition. As seen best in FIGS. 7-13, this form of the invention comprises a clamping member 31, a base member 40 attached to the bottom of the clamping member, a quick connect 50 attached to the top of the clamping member, and a cap 60 covering the quick connect.

The clamping member 31 has opposed jaws 32A and 32B connected for movement toward and away from one another by first cross pieces 33A and 34A that each have one end fixed to jaw 32A and a free end spaced from jaw 32B, second cross pieces 33B and 34B that each have one end fixed to jaw 32B and a free end spaced from jaw 32A, and a rod 35 fixed at one end 35A to jaw 32A and an opposite bifurcated end 35B slidably engaged through an opening in jaw 32B. A coil spring 36 around rod 35 is engaged between the jaws to urge them apart. The cross pieces 33A and 34A are slidably interengaged with respective opposite cross pieces 33B and 34B, and inturned detents 37 on their adjacent ends limit outward movement of the jaws away from one another. In the specific example shown, the cross pieces 33A, 34A and 33B, 34B are rectilinear in transverse cross section and together with the rod 35 maintain the jaws in aligned parallel relationship with one another. A cam lock 38 is pinned to the bifurcated end 35B of rod 35 that projects through jaw 32B to move the jaws toward one another to clamp the rail 13 between them when the cam is moved from the position shown in FIG. 8 to the position shown in FIG. 7. Movement of the cam lock from the position shown in FIG. 8 to the position shown in FIG. 7 permits the spring to urge the jaws away from one another to release the clamp 30 from the rail 13.

The base member 40 (seen best in FIGS. 7 and 8) comprises a main body wall 41 with upstanding end walls 42 and 43 at opposite ends thereof and a plurality of transversely extending spaced parallel ribs 44 on its bottom surface. Openings 45 for receiving fasteners as described hereinafter are formed in the upper surfaces of the end walls 42 and 43.

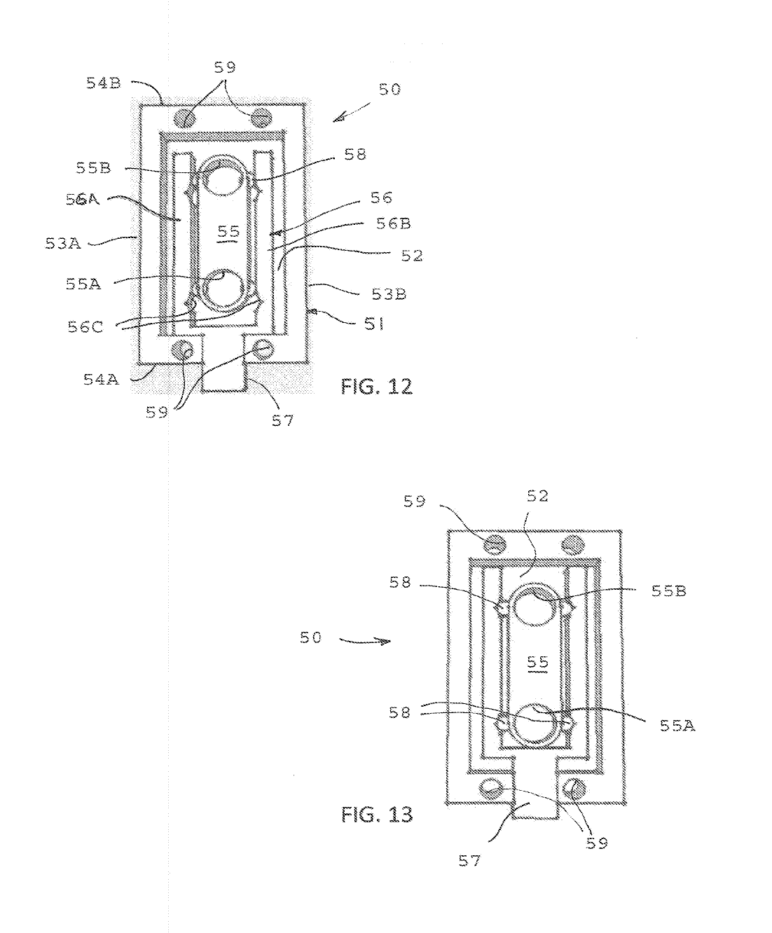

The quick connect 50, as seen best in FIGS. 7, 8, 12 and 13, comprises a shallow box-like housing 51 having a bottom wall 52, opposite side walls 53A and 53B, opposite end walls 54A and 54B, and an open top. A quick connect receptacle 55 having sockets 55A and 55B in its opposite ends stands upwardly into the housing from the bottom wall, and a tuning-fork-shaped locking member 56 has arms 56A and 56B extending closely along respective opposite sides of the receptacle. An extension 57 on one end of the locking member projects through one end wall of the housing and may be engaged to push the locking member from the unlocked position shown in FIG. 12 to the locked position shown in FIG. 13. Ball-bearing-like locking detents 58 are engaged in openings at opposite sides of the receptacle in registry with the sockets 55A and 55B so that the detents project outwardly beyond the outer sides of the receptacle and a short distance into the sockets. Shallow recesses 56C in the surfaces of the arms 56A and 56B are adapted to come into and out of registry with the detents so that when the locking member is moved to its unlocked position the detents move outwardly into the recesses and away from gripping engagement with a locking member (not shown) received in the sockets. When the locking member is moved to its locked position, the arms 56A and 56B push the detents inwardly into frictional locking engagement with an object received in the sockets. Openings 59 extend through the end walls 54A and 54B for receiving fasteners as described hereinafter.

The cover 60 simply comprises a flat rectangular plate that is positioned on top of the quick connect and suitable fasteners such as screws or bolts or the like 61 are extended through openings 62 in opposite ends of the cover and through the openings 59 in the quick connect and into the openings 45 in the base member end walls to hold the parts assembled and form a unitary clamp construction as seen in FIG. 6. It will be noted that with the parts assembled, the end walls 42 and 43 on the base member extend flush between respective opposite ends of the jaws 32A and 32B of the clamping member and substantially coplanar with the end walls 54A and 54B of the quick connect. Openings 63 through the cover provide entry for a male quick connect device into the female sockets 55A and 55B in the quick connect 50.

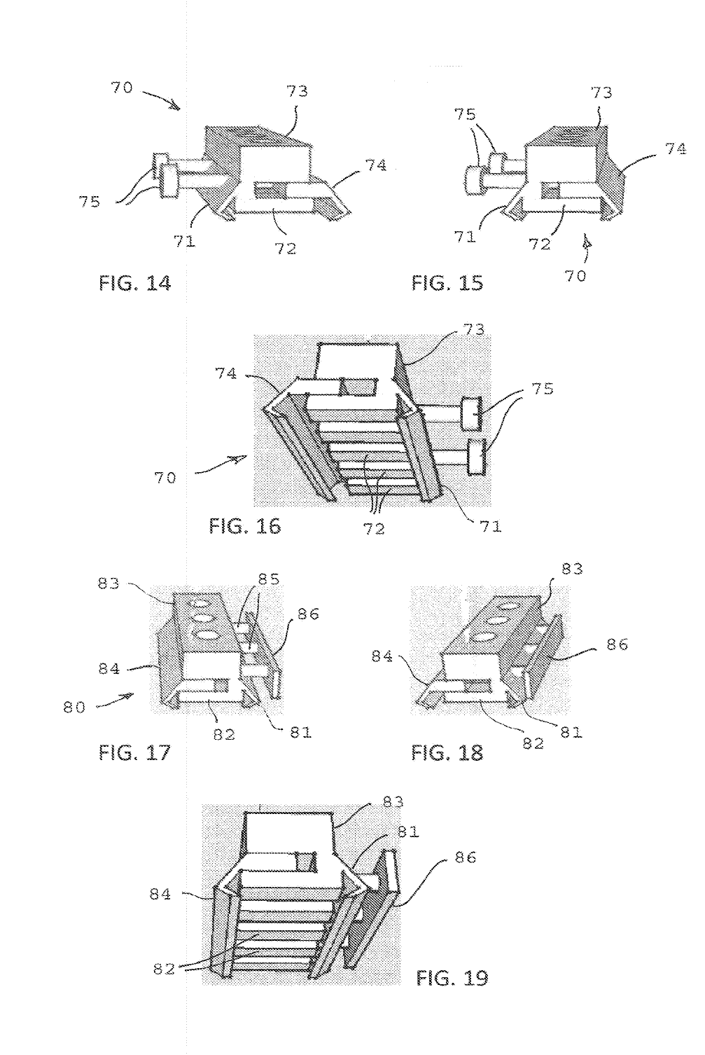

A further embodiment of clamp is shown at 70 in FIGS. 14-16. In this form of the invention, one clamping jaw 71 and a plurality of parallel spaced apart ribs or bars 72 are formed integrally with clamp body 73. The bars 72 are spaced below and extend parallel to the bottom surface of body 73, and a movable clamping jaw 74 is reciprocable in this space. One or more thumb screws 75 are threaded through body 73 at the base of clamping jaw 71 and are connected with the movable clamping jaw 74 to move the clamping jaw 74 toward and away from jaw 71 when the thumb screws are turned.

Another embodiment of clamp is shown at 80 in FIGS. 17-19. As in that form of the invention shown in FIGS. 14-16, one clamping jaw 81 and a plurality of parallel spaced apart ribs or bars 82 are formed integrally with clamp body 83. The bars 82 are spaced below and extend parallel to the bottom surface of body 83, and a movable clamping jaw 84 is reciprocable in this space. One or more rods 85 extend through openings in body 83 at the base of clamping jaw 81 and are connected with the movable clamping jaw 84 to move the clamping jaw 84 toward and away from jaw 81 when the rods are moved by a plate or bar 86 that may be attached to the outer ends of rods 85 to move them in unison and facilitate their operation. The movable jaw 84 may be spring loaded (not shown), if desired, to urge it toward fixed jaw 81.

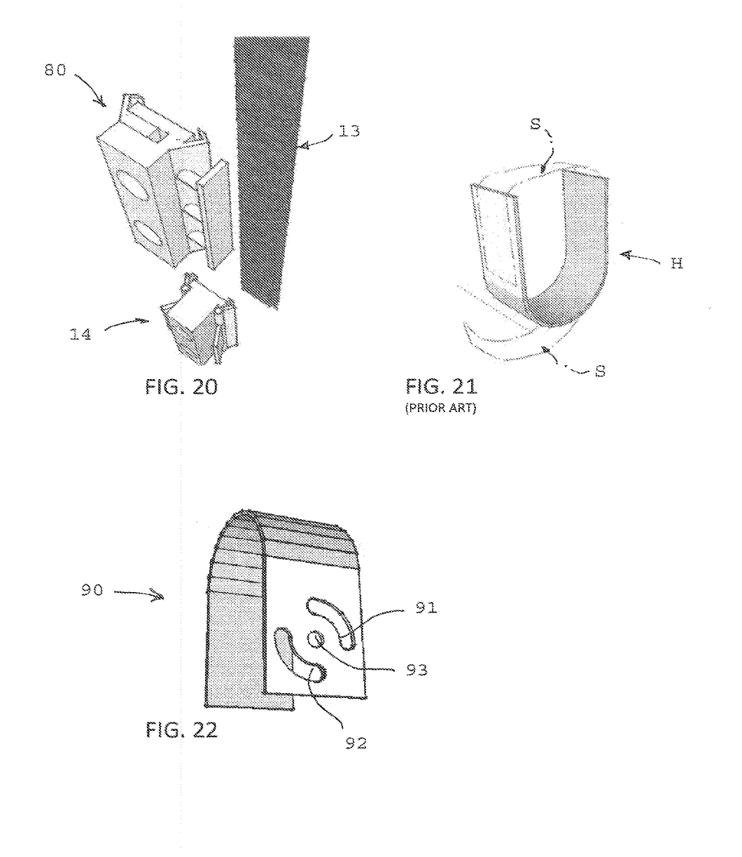

Different clamps of the invention may be used in combination, as depicted at 14 and 80, respectively, in FIG. 20, shown exploded away from a Picatinny-type rail 13.

A conventional utility hook H is shown in FIG. 21, with an optional Velcro® strap S attached to the hook for securing an object (not shown) to the hook. The hook is available from Rugged Gear of Elk Point, S. Dak., and is made of aluminum that may be easily deformed to increase or decrease the space between the legs of the hook.

A modified hook 90 is shown in FIG. 22, wherein the hook is depicted in an inverted position and has arcuate slots 91 and 92 in one of its legs spaced outwardly on opposite sides of a central hole 93. The slots permit easy adjustment to any position over a range of 90°.

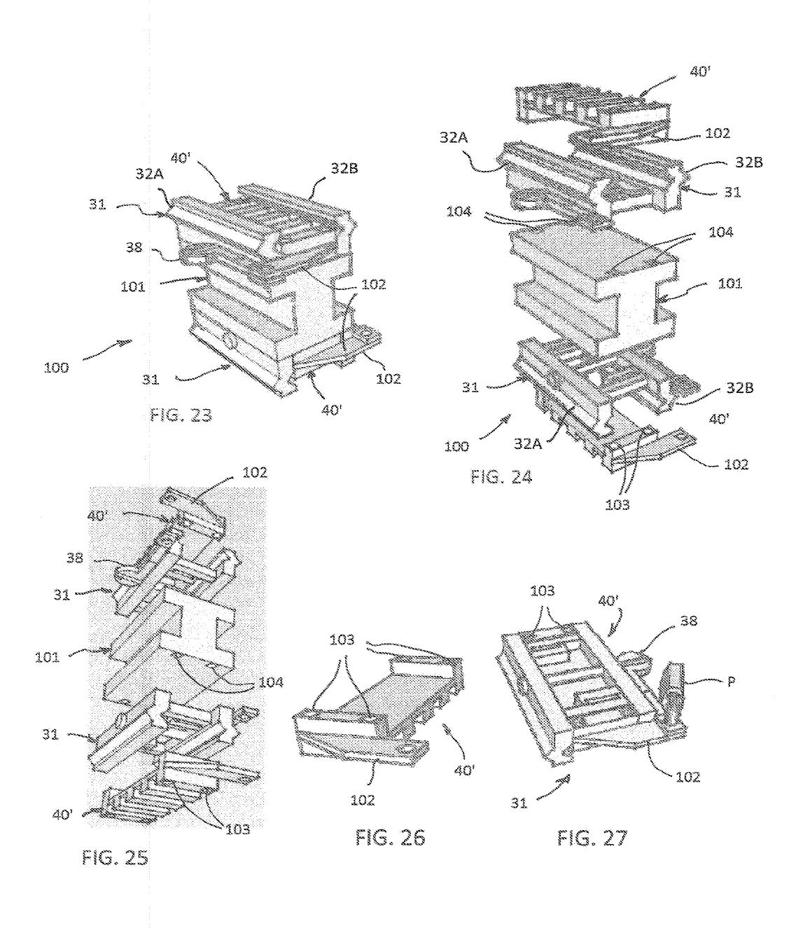

FIGS. 23-27 depict another form of the invention wherein a coupler 101 is connected between two clamping members 31 to form a clamp assembly 100. Suitable fasteners (not shown) are extended through openings 103 in opposite ends of modified bases 40′ and into threaded holes 104 in the top and bottom surfaces of the coupler at opposite ends thereof to hold the clamp assembly together as shown in FIG. 23. A locking tab 102 on one end of the base 40′ extends laterally into position to overlap with the operating arm of cam lock 38 when the cam lock is in closed position, and a padlock P may be engaged in holes in the arm and tab to lock the clamping member in closed position on a rail.

As seen best in FIGS. 24-28, the clamp assembly 100 comprises coupler 102 connected between two clamping members 31 each with a modified base 40′. The clamping members 31 are identical to those shown in FIGS. 6-11, including cam locks 38. The modified bases 40′ differ from the base shown in FIGS. 6-8 in that a lock tab 102 is formed on one end of the base. The lock tab extends laterally into a position that aligns with the end of the cam lock when the cam lock is in closed position to clamp the jaws 32A and 32B against opposite sides of the rail, and a padlock P may be inserted through openings in the overlapped portions of the lock tab and cam lock to secure the cam lock in its closed condition and thus lock the clamp member to the rail. With this arrangement the clamp assembly 100 may be securely locked to the rail on a firearm and to a second rail that is suitably fastened to a surface. See FIG. 29, which shows a modified clamp assembly for mounting a firearm to a rail extending horizontally on a wall.

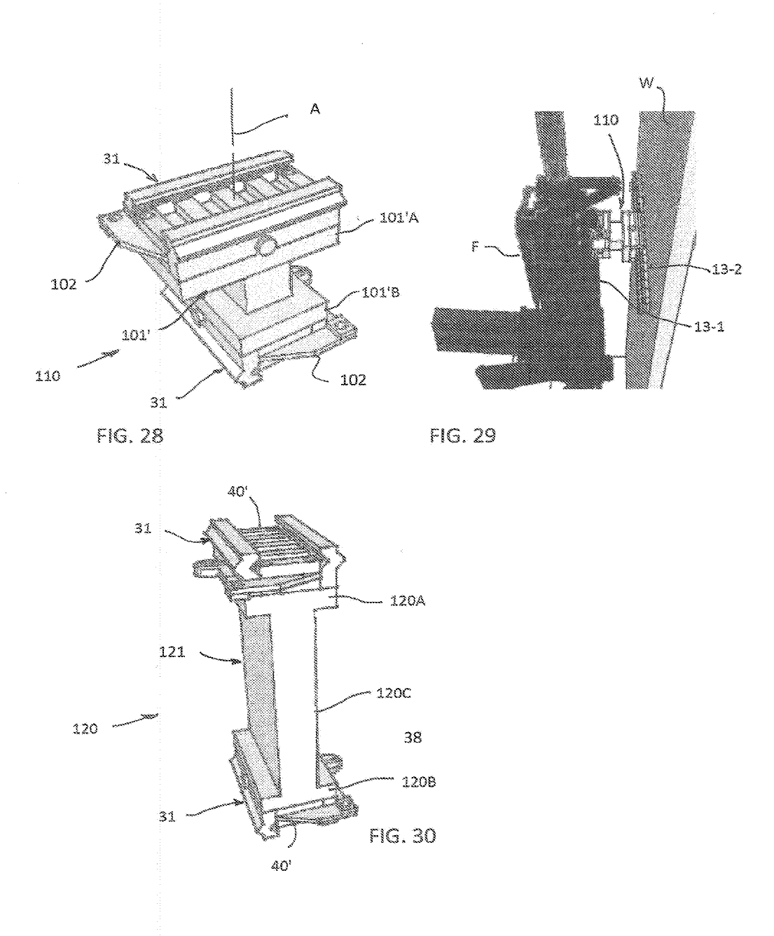

A modified clamp assembly 110 is shown in FIG. 28, wherein the platforms 101′A and 101′B at opposite ends of the coupler 101′ are rotationally displaced 90° with respect to one another about the longitudinal axis A of the coupler. Thus, the coupler 101′ could be used to interconnect two rails that are rotationally displaced with respect to one another. An example is depicted in FIG. 29, wherein the clamping member 31 at one end of the clamp assembly 110 is locked to the rail 13-1 on a firearm F, and the clamping member 31 at the other end of the clamp assembly is locked to the rail 13-2 on a wall.

A further modified clamp assembly 120 is shown in FIG. 30, wherein the central column 120C extending between the platforms 120A and 120B of coupler 121 is elongate to form a stand-off for spacing one item from another item (not shown) coupled together with the coupler.

The modular clamp system of the invention can be mounted to almost any surface and provides great flexibility in designing systems for supporting a variety of objects on a variety of other objects and surfaces. The system of the invention is compatible with all currently available Picatinny rail accessories, which can be mounted to the clamp platform with screws (not shown) or the quick connect mechanism disclosed herein.

What is claimed is:

1. A modular and easily customizable system for mounting a first article to a second article, comprising a Picatinny-type rail attachable to the first article and a clamp assembly attachable to the rail and to which the second article may be mounted, wherein the clamp assembly comprises:
a clamping member having a base configured to interlock with the rail; and
a quick-connect device serving as a platform for quickly and easily attaching the second article to the clamp and thus to the rail.

2. A modular and easily customizable clamp assembly for mounting a first article to a second article, wherein the clamp assembly comprises a coupler joining two clamping members each of which has a base attachable to a respective different Picatinny-type rail, each said base being configured to interlock with a respective said rail and each having a lock member to secure the associated clamping member in locked position on a respective rail.
